(19) United States
(12) Patent Application Publication
(10) Pub. No.: US 2020/0313354 A1
(43) Pub. Date: Oct. 1, 2020

(54) ELECTRICAL CONNECTOR WITH FLOATING CONTACT ELEMENT

(71) Applicant: METHODE ELECTRONICS, INC., Chicago, IL (US)

(72) Inventors: Chip BRONK, San Jose, CA (US); Hannah HAN, Fremont, CA (US); Robert KELLER, Rolling Meadows, IL (US); Michael STIBGEN, Rolling Meadows, IL (US)

(21) Appl. No.: 16/829,672

(22) Filed: Mar. 25, 2020

Related U.S. Application Data
(60) Provisional application No. 62/823,257, filed on Mar. 25, 2019.
(60) Provisional application No. 62/916,857, filed on Oct. 18, 2019.

(51) Int. Cl. H01R 13/631; H01R 13/11; H01R 13/502

(52) U.S. Cl. CPC H01R 13/6315; H01R 13/502; H01R 13/111

(57) ABSTRACT

An electrical connector for use with a separable mating connector includes base and a contact element captively received within the base. The contact element may be laterally or laterally and rotatably displaceable with respect to the base.

### CROSS-REFERENCE TO RELATED APPLICATIONS

This application claims benefit under 35 U.S.C. § 119 of U.S. Provisional Patent Application No. 62/823,257, filed on Mar. 25, 2019, and U.S. Provisional Patent Application No. 62/916,857, filed on Oct. 18, 2019, and it incorporates by reference the disclosures thereof in their entireties.

In addition, the subject matter of the following applications is incorporated herein by reference in its entirety: U.S. Utility application Ser. No. ______ filed Mar. 25, 2020, and entitled ELECTRICAL CONNECTOR WITH FLOATING CONTACT ELEMENT (B&T Ref. No. 49072-318080); U.S. Utility application Ser. No. ______ filed Mar. 25, 2020, and entitled ELECTRICAL CONNECTOR WITH FLOATING CONTACT ELEMENT (B&T Ref. No. 49072-318286); and U.S. Utility application Ser. No. ______ filed Mar. 25, 2020, and entitled ELECTRICAL CONNECTOR WITH FLOATING CONTACT ELEMENT (B&T Ref. No. 49072-318287).

### BACKGROUND AND SUMMARY OF THE DISCLOSURE

An electrical equipment cabinet may include a bus bar bearing a number of electrical connector sockets received in corresponding holes in the bus bar. A piece of electrical equipment may include mating electrical connector pins configured for insertion into the connector sockets borne by the bus bar.

Failure to precisely locate the connector sockets with respect to the bus bar and/or the connector pins with respect to the electrical equipment, for example, due to manufacturing tolerances, can result in misalignment of the sockets and pins. Such misalignment can inhibit or adversely affect the quality of the electrical connection between corresponding sockets and pins.

The present disclosure is directed to an electrical connector having a floating contact element disposed within a mounting body. The mounting body is configured for connection to a bus bar, for example, in a conventional manner, and the contact element is configured to float with respect to the mounting body. The ability of the contact element to float with respect to the mounting body allows the electrical connector to compensate for misalignment of a corresponding connector element with respect to the mounting body of the electrical connector.

### BRIEF DESCRIPTION OF THE DRAWINGS

FIG. 1 illustrates a bus bar defining four apertures and four electrical connector sockets disposed in the apertures;

FIG. 2 is a side cross sectional-view of an illustrative electrical contact element;

FIG. 3 is a top plan view of the contact element of FIG. 2;

FIG. 4 is a perspective view of an illustrative embodiment of an electrical connector having a floating contact element disposed within a mounting body, according to the present disclosure;

FIG. 5 is a cutaway perspective view of the electrical connector of FIG. 4;

FIG. 6 is a cutaway front view of the electrical connector of FIG. 4;

FIG. 7 is a cutaway side view of the electrical connector of FIG. 4;

FIG. 8 is an exploded perspective view of the electrical connector of FIG. 4;

FIGS. 9A-9D are plan views of the electrical connector of FIG. 4 with the floating contact element in various orientations with respect to the mounting body; and

FIG. 10 is a perspective view of the electrical connector of FIG. 4 installed in a bus bar.

### DETAILED DESCRIPTION OF THE DRAWINGS

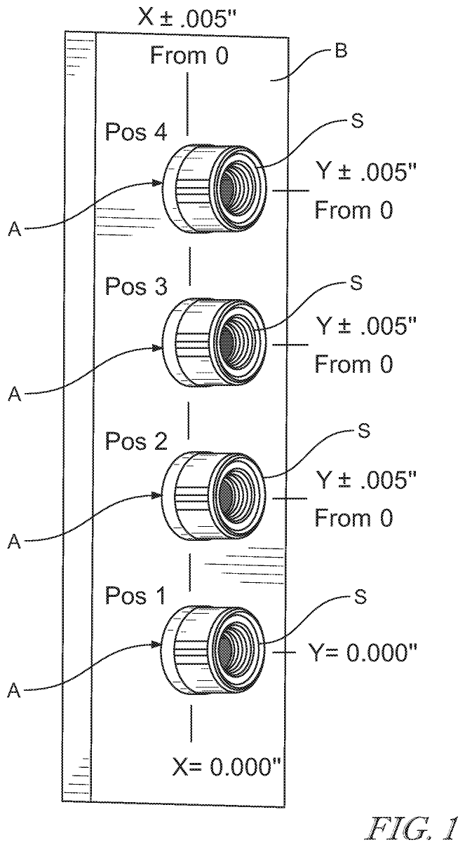

FIG. 1 shows a bus bar B as might be found in an electrical equipment cabinet (not shown). The bus bar BB defines four apertures A arranged linearly proximate four corresponding, predetermined aperture locations. The actual locations of the apertures A may vary somewhat from the predetermined aperture locations due to manufacturing tolerances. FIG. 1 also illustrates four electrical connector sockets S, each disposed within a corresponding one of the apertures A.

The predetermined aperture locations may correspond to predetermined locations of corresponding, mating electrical connector pins extending from a piece of electrical equipment (not shown) that may be removably received within the cabinet (not shown). The piece of electrical equipment may be, for example, an electrical equipment drawer removably receivable within the cabinet, or a piece of electrical equipment mounted on such a drawer. The actual locations of the pins (not shown) may vary somewhat from the corresponding predetermined aperture locations due to manufacturing tolerances.

The foregoing deviations of the aperture and pin locations from the respective predetermined locations, as well as manufacturing variations in the sockets S and the pins (not shown) themselves, can yield misalignment of respective sockets and pins. At worst, the misalignment may preclude insertion of the pins into the sockets. In less severe cases, the misalignment may adversely affect the quality of the electrical connection between the respective pins and sockets.

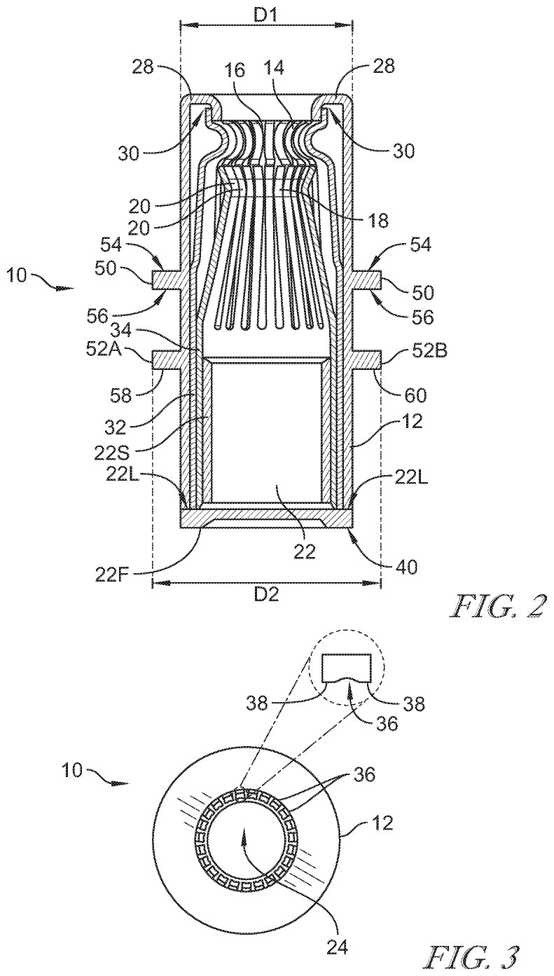

FIGS. 2 and 3 show an illustrative electrical contact element 10 including a generally cylindrical housing 12, a first generally cylindrical array 14 of flexible beams 16 received concentrically within the housing 12, a second generally cylindrical array 18 of flexible beams 20 received concentrically within the first array 14 of flexible beams 16, and a ferrule 22 having an annular shaft 22S received concentrically within the second array 18 of flexible beams 20. Individually and collectively, the housing 12, the first array 14 of flexible beams 16, the second array 18 of flexible beams 20, and the ferrule 22 define a cavity configured to seperably receive a pin of a contact element of a mating electrical connector (not shown).

The housing 12 is shown as an annular sidewall having a first end and a second end. The sidewall of the housing 12 has an outer diameter D1 and an inner diameter D2. A hood 28 extends radially inwardly from the second end of the housing 12 and then turns toward the first end of the housing 12, thereby defining an annular channel or slot 30 between the sidewall of the housing 12 and the free end of the hood 28.

A circumferential flange 50 extends radially outwardly from the sidewall of the housing 12 intermediate the first end and the second end of the sidewall, for example, about midway between the first end and the second end of the sidewall. In the embodiment shown, the circumferential flange 50 encircles the entirety of the housing 12. The circumferential flange 50 has an outside diameter substantially greater than the outside diameter of the sidewall of the housing 12.

A first part-circumferential flange 52A extends radially outwardly from the sidewall of the housing 12 intermediate the first end of the sidewall and the circumferential flange 50, for example, about one third of the distance from the first end toward the second end of the sidewall. The first part-circumferential flange 52A has an outer radius about equal to one half the second outside diameter D2.

Similarly, a second part-circumferential flange 52B extends radially outwardly from the sidewall of the housing 12 intermediate the first end of the sidewall and the circumferential flange 50, for example, about one third of the distance from the first end toward the second end of the sidewall. The second part-circumferential flange 52B has an outer radius about equal to one half the second outside diameter D2.

In the embodiment shown, the first part-circumferential flange 52A and the second part-circumferential flange 52B are disposed at the same axial distance from the first end of the housing 12. Each of the first part-circumferential flange 52A and the second part-circumferential flange 52B extends about a portion of the periphery of the housing 12 over a corresponding arc length, as will be discussed further below. The respective arc lengths of the first part-circumferential flange 52A and the second part-circumferential flange 52B may be the same as or different from each other. The first part-circumferential flange 52A may be located diametrically opposite the second part-circumferential flange 52B with respect to the housing 12.

The first array 14 of flexible beams 16 is shown as extending from a generally cylindrical base 32 abutting the housing 12 proximate the first end thereof. The first array 14 of beams 16 extends axially from the base 32 and radially inwardly toward the center of the cylinder defined by the first array 14 of flexible beams 15. Similarly, the second array 18 of flexible beams 20 is shown as extending from a generally cylindrical base 34 abutting the base 32 of the first array 14 of flexible beams 16 proximate the first end thereof. The first array 18 of flexible beams 20 extends axially from the base 34 and radially inwardly toward the center of the cylinder defined by the second array 18 of flexible beams 20. In an embodiment, the second array 18 of flexible beams 20 may be omitted. In other embodiments, other electrical contact arrangements defining a cylindrical cavity could be provided in lieu of either or both of the arrays 14, 18 of flexible beams 16, 20.

As suggested above, the ferrule 22 includes a generally circular flange 22F defining an aperture therethrough, and a generally annular shaft 22S defining a bore extending therethrough. The shaft 22S is connected to the flange 22F so that bore of the shaft 22S is generally concentric with the aperture of the flange 22F. The flange 22F has a second outer diameter D3 substantially greater than the first outer diameter D1 of the housing 12. As such, the flange 22F defines a bearing surface or land 22L extending radially outwardly from the sidewall of the housing 12.

All of the foregoing components of the contact element 10 are electrically conductive, and they are electrically coupled to each other. The first inner diameter D2 of the housing 12, the outer diameter D3 of the shaft 22S, and the diameters of the bases 32, 34 of the first and second arrays 14, 18 of flexible beams 16, 20 are selected so that the bases 32, 34 are compressed against each other and between the housing 12 and the ferrule 22 when the housing 12, the first and second bases 32, 34, and the ferrule 22 are assembled as shown and as described above.

As best shown in FIG. 3, the distal portion of each of the flexible beams 16, 20 extending from the respective base 32, 34 defines a contact area 36 configured to engage the mating connector (not shown) in electrical contact therewith. In some embodiments, the contact area 36 may be formed to define two contact points or surfaces 38. In other embodiments, the contact areas 36 may be formed to define more or fewer than two contact points or surfaces 38. As best shown in FIG. 2, the distal end of each beam of the first array 14 of flexible beams 16 may be radially captured within the slot 30 defined by the sidewall of the housing 12 and the free end of the hood 28.

As suggested above, the contact element 10 may be configured to receive therein a pin of mating electrical connector (not shown) in electrical engagement, so that low force is required to assemble the mating connector element to, and to disassemble the mating connector element from, the contact element 10.

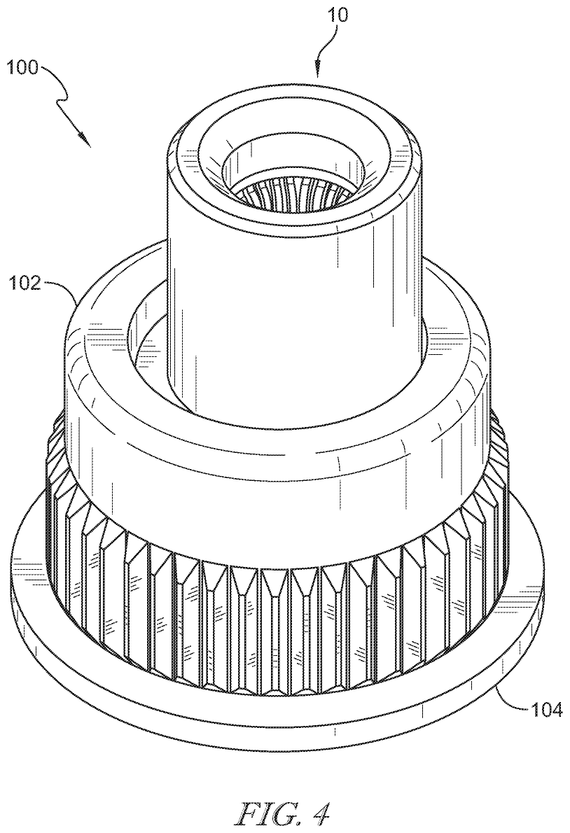

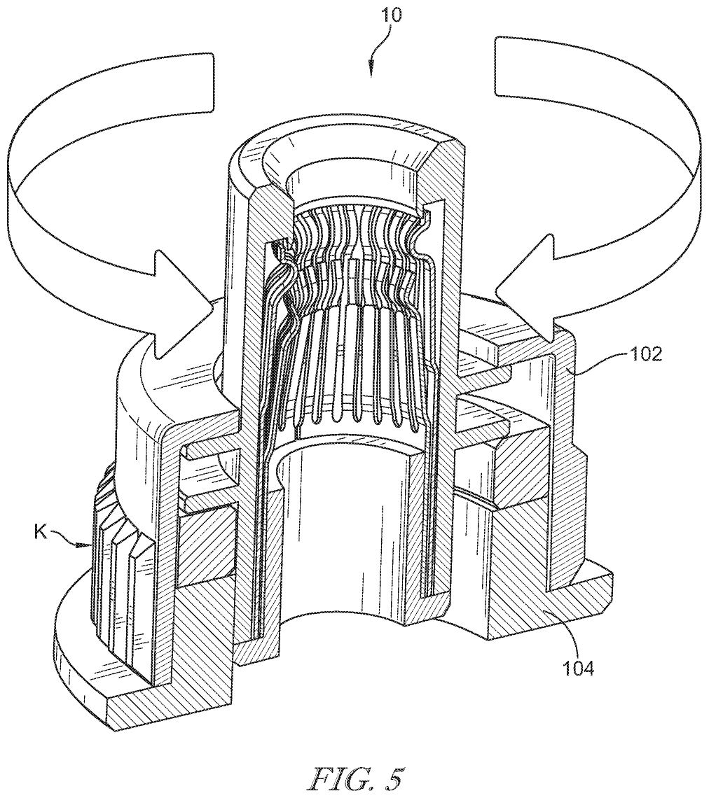

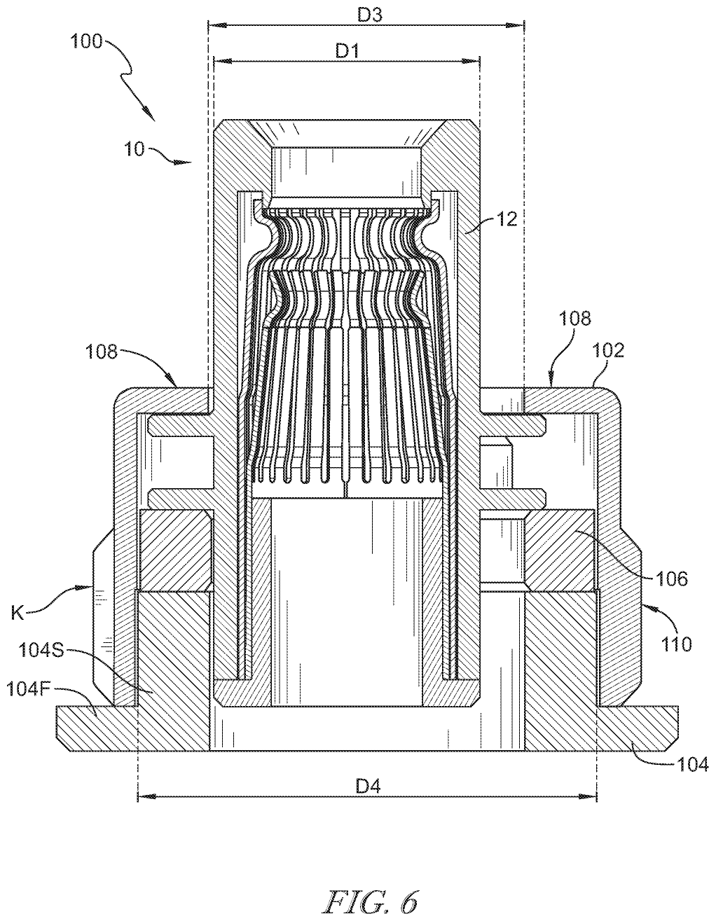

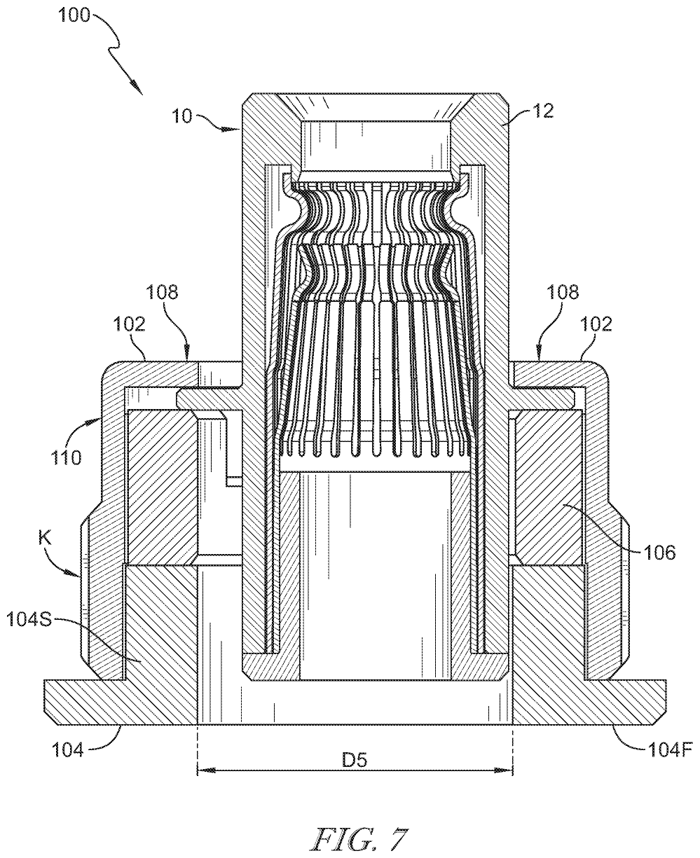

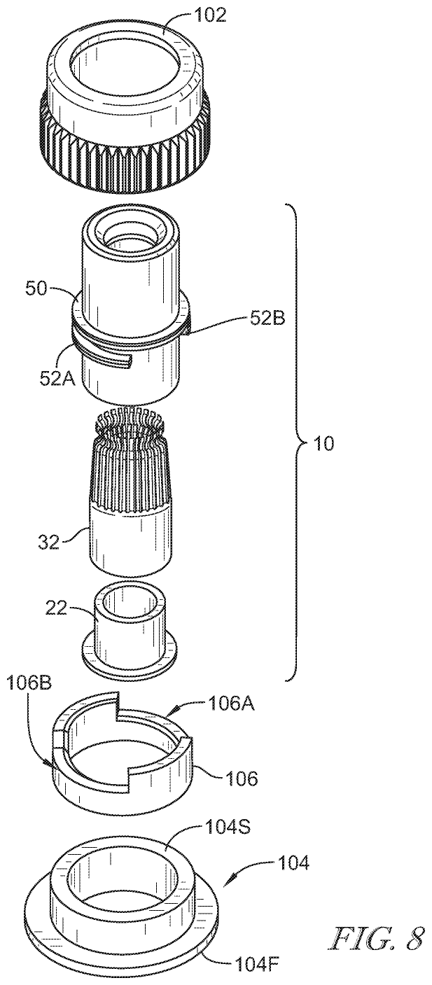

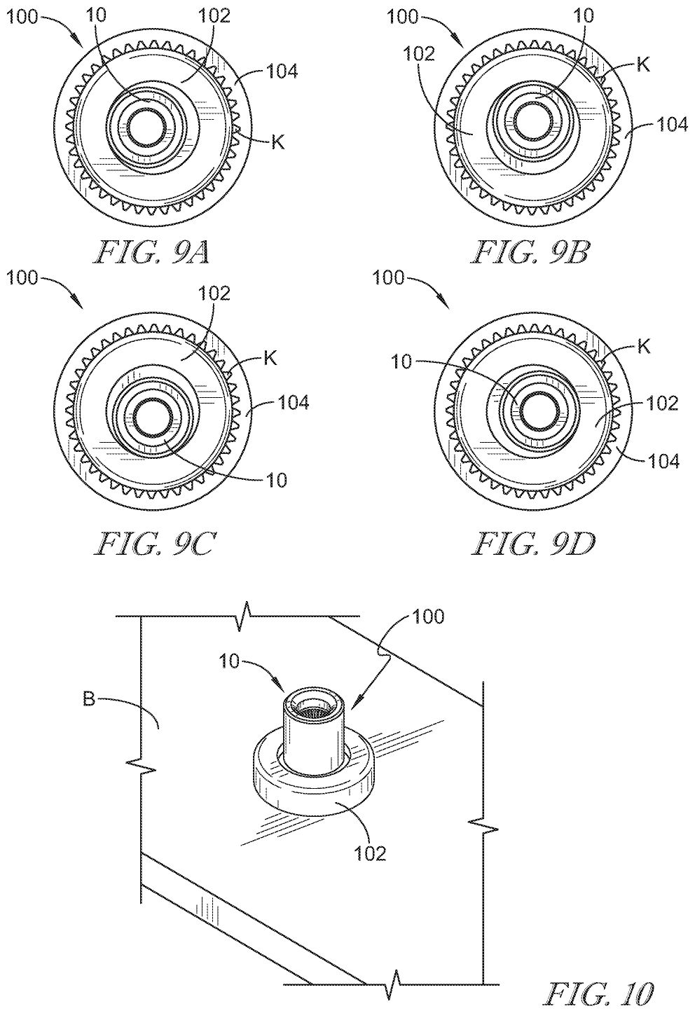

FIG. 4-9 show an illustrative embodiment of an electrical connector 100 according to the present disclosure. FIG. 10 shows the connector 100 installed in a bus bar B.

The connector 100 includes the contact element 10, a mounting base 102 configured to receive the contact element, a retainer 104 configured to capture the contact element 10 to the mounting base 102, and a spacer 106 disposed between the retainer and the flanges 50, 52A, 52B of the contact element 10. At least the contact element 10 and the mounting base 102 are electrically conductive and in electrical engagement with each other.

More specifically, the mounting base 102 includes a generally circular flange 108 defining an aperture therethrough. The aperture defined by the flange 108 has an inner diameter D3 substantially greater than the outer diameter D1 of the housing 12 of the contact element 10, and substantially lesser than the outer diameter D2 of the circumferential flange 50 of the contact element 10. A generally cylindrical sidewall 110 defining a bore therethrough extends axially from the flange 108, with the bore of the sidewall 110 generally concentric with the aperture of the flange 108. The bore defined by the sidewall 110 has an inner diameter D4 substantially greater than the outer diameter D2 of the circumferential flange 50 of the contact element 10 and twice the radii of the first and second part-circumferential flanges 52A, 52B of the contact element 10, thereby allowing substantial lateral (or radial) displacement and/or rotation of the flanges 50, 52A, 52B with respect to the sidewall 110 when the contact element 10 is assembled to the base 102 as shown and as will be discussed further below.

A portion of the outer surface of the sidewall 110 may define knurls K configured to facilitate secure engagement of the mounting base 102 to a bus bar B, for example, as shown in FIG. 10.

The retainer 104 is shown as a ferrule having a flange 104F and a shaft 104S extending axially from the flange 104F. The flange 104F and the shaft 104S cooperate with each other to define an aperture therethrough. The aperture has an inner diameter D5 sufficiently greater than the outer diameter D1 of the housing 12 of the contact element 10 to thereby allow the first end of the housing 12 to be received through the retainer 104 when the contact element 10 is assembled to the retainer 104 as shown and as will be discussed further below. The inner diameter D5 may be the same as or similar to the inner diameter D3 of the flange 108 of the base 102. Also, the shaft 104S has an outer diameter about equal to the inner diameter of the sidewall 110, thereby enabling press-fit engagement of the shaft 104S and the sidewall 110 to each other, and inhibiting unintended disassembly of the assembled connector 100.

The spacer 106 is shown as an annular ring defining first and second notches 106A, 106B. The notches 106A, 106B extend over arc lengths corresponding to and longer than the arc lengths of the first and second part-circumferential flanges 52A, 52B. As such, the first and second part-circumferential flanges 52A, 52B may be received within the corresponding ones of the first and second notches 106A, 106B. Because the arc lengths of the first and second part-circumferential flanges 52A, 52B are shorter than the arc lengths of the first and second notches 106A, 106B, respectively, the contact element 10 may rotate to a limited degree with respect to the spacer 106 while received therein.

The connector 100 may be assembled by inserting the contact element 10 into the base 102 with an upper surface 54 of the circumferential flange 50 of the housing 12 in sliding engagement with a corresponding inner surface of the flange 108 of the base 102. The spacer 106 may be inserted into the base 102 with an upper surface of the spacer in sliding engagement with a lower surface 56 of the circumferential flange 50 of the housing 12, and with upper surfaces of the first and second notches 106A, 106B in sliding engagement with respective lower surfaces 58, 60 of the first and second part-circumferential flanges 52A, 52B. The retainer 104 may be inserted in the base 102 and in press fit engagement therewith to capture the spacer 106 and the connecting element between the base and the retainer. With the connector 100 so assembled, the circumferential flange 50 may be slidably and rotatably engaged with the inner surface of the flange 108 and the upper surface of the spacer 106. Also, the first and second part-circumferential flanges 52A, 52B may be slidably and rotatably engaged with the upper surfaces of the first and second notches 106A, 106B. Any or all of the foregoing engagement may be frictional, so that a substantial external force may be required to laterally and/or rotatably displace the connecting element 10 with respect to the body 102. Also, the foregoing engagements may preclude pivoting of the connecting element 10 with respect to the body 102,

Because the outer diameter D2 of the circumferential flange 50 of the housing 12 is substantially less than the inner diameter D4 of the sidewall 110 of the mounting base 102, because the radii of the part-circumferential flanges 52A, 52B are substantially less than one-half the inner diameter D4 of the sidewall 110 of the mounting base 102, and because the outer diameter D1 of the housing 12 is substantially less than the inner diameter D5 of the aperture defined by the retainer 104 (and the corresponding aperture defined by the spacer 106), the entire contact element 10 may be substantially displaced at least laterally with respect to the mounting base 102. In some embodiments, the contact element 10 may be rotatable to a limited degree with respect to the mounting base 102.

In an embodiment, the first and second part-circumferential flanges 52A, 52B may be omitted from the housing 12, and the first and second notches 106A, 106B may be omitted from the spacer 106. In such an embodiment, the contact element 10 may be rotatable with respect to the mounting base 102.

Various illustrative, non-limiting embodiments of an electrical connector and mating connector are shown and described herein. Features shown in connection with a given embodiment may be incorporated into any other embodiment to the greatest extent possible. Dimensions, tolerances, and the like that may be shown or described herein are illustrative and not limiting.

1. An electrical connector for use with a separable mating electrical connector, the electrical connector comprising:
a mounting base configured for secure insertion into an aperture defined by a bus bar, the mounting base defining a bore having an inner diameter, and the annular base having a longitudinal axis;
a cylindrical contact element disposed within the bore of the mounting base, the cylindrical contact element having a first end and a second end, the cylindrical contact element defining a bore configured to receive a pin of the separable mating connector in continuous electrical engagement therewith, the cylindrical contact element comprising:
a cylindrical housing having an inner diameter and an outer diameter lesser than the inner diameter of the bore of the mounting base;
a circumferential flange extending radially outwardly from the cylindrical housing proximate the first end of the cylindrical housing, the first circumferential flange having an outer diameter;
a first part-circumferential flange extending radially outwardly from the cylindrical housing proximate the second end of the cylindrical housing, the first part-circumferential flange having a first radius and a first arc length; and
a second part-circumferential flange extending radially outwardly from the cylindrical housing proximate the second end of the cylindrical housing, the second part-circumferential flange having a second radius and a second arc length;
an annular spacer disposed about the cylindrical contact element and within the mounting base; and
an annular retainer receiving the cylindrical contact element therein and capturing the cylindrical contact element and the annular spacer to the mounting base,
wherein the diameter, the first radius, the second radius, and the inner diameter of the bore of the mounting base are selected to allow substantial radial movement of the cylindrical contact element with respect to the mounting base; and
wherein the cylindrical contact element is electrically engaged with the mounting base.

2. The electrical connector of claim 1 wherein the annular retainer is in press-fit engagement with an inner surface of the mounting base.

3. The electrical connecter of claim 1 further comprising a first cylindrical array of flexible beams extending toward the second end of the cylindrical housing of the cylindrical contact element from a base disposed radially within the housing of the cylindrical contact element and proximate the first end of the cylindrical housing of the cylindrical contact element.

4. The electrical connector of claim of claim 3 further comprising a second cylindrical array of flexible beams extending toward the second end of the cylindrical housing of the cylindrical contact element from a base disposed radially within the base of the first array of flexible beams of the cylindrical contact element and proximate the first end of the housing of the cylindrical contact element.

5. The electrical connector of claim 1 wherein the cylindrical contact element further comprises a ferrule having an annular shaft and a circular flange connected to the annular shaft at a first end thereof, the annular shaft received radially within the cylindrical housing.

6. The electrical connector of claim 5 wherein the annular shaft is radially received within the first array of flexible beams.

7. The electrical connector of claim 5 wherein the annular shaft is radially received within the second array of flexible beams.

8. The electrical connector of claim 1,
wherein the annular spacer defines a first notch corresponding to the first part-circumferential flange and a second notch corresponding to the second part-circumferential flange,
wherein the first notch has a third arc length greater than the first arc length,
wherein the second notch has a fourth arc length greater than the second arc length,
wherein the first part-circumferential flange is received within the first notch,
wherein the second part-circumferential flange is received within the second notch, and
wherein the contact element thereby is free to rotate with respect to the mounting base through a predetermined arc.

9. An electrical connector for use with a separable mating electrical connector, the electrical connector comprising:
a base configured for secure insertion into an aperture defined by a bus bar, the base defining a bore having an inner diameter, and the base having a longitudinal axis;
a contact element disposed within the bore of the base, the contact element having a first end and a second end, the contact element defining a bore configured to receive a pin of the separable mating connector in continuous electrical engagement therewith, the contact element comprising:
a housing having a first end, a second end, an inner diameter, and an outer diameter lesser than the inner diameter of the bore of the base;
a circumferential flange extending radially outwardly from the housing proximate the first end of the housing, the first circumferential flange having an outer diameter;
a first part-circumferential flange extending radially outwardly from the housing proximate the second end of the housing, the first part-circumferential flange having a first radius and a first arc length; and
a second part-circumferential flange extending radially outwardly from the housing proximate the second end of the housing, the second part-circumferential flange having a second radius and a second arc length; and
a retainer receiving the contact element therein and capturing the contact element to the base,
wherein the diameter, the first radius, the second radius, and the inner diameter of the bore of the base are selected to allow substantial radial movement of the annular contact element with respect to the base; and
wherein the contact element is electrically engaged with the base.

10. The electrical connector of claim 16 wherein the retainer is in press-fit engagement with an inner surface of the base.

11. The electrical connecter of claim 9 further comprising a first array of flexible beams extending toward the second end of the housing of the contact element from a base disposed radially within the housing of the contact element and proximate the first end of the housing of the contact element.

12. The electrical connector of claim of claim 11 further comprising a second array of flexible beams extending toward the second end of the housing of the contact element from a base disposed radially within the base of the first array of flexible beams of the contact element and proximate the first end of the housing of the contact element.

13. The electrical connector of claim 12 wherein the contact element further comprises a ferrule having a shaft and a flange connected to the shaft at a first end thereof, the shaft received radially within the housing.

14. The electrical connector of claim 13 wherein the annular shaft is radially received within the first array of flexible beams.

15. The electrical connector of claim 14 wherein the annular shaft is radially received within the second array of flexible beams.

16. The electrical connector of claim further comprising a spacer disposed about the contact element and within the base,
wherein the spacer defines a first notch corresponding to the first part-circumferential flange and a second notch corresponding to the second part-circumferential flange,
wherein the first notch has a third arc length greater than the first arc length,
wherein the second notch has a fourth arc length greater than the second arc length,
wherein the first part-circumferential flange is received within the first notch,
wherein the second part-circumferential flange is received within the second notch, and
wherein the contact element thereby is free to rotate with respect to the base through a predetermined arc.

17. An electrical connector for use with a separable mating electrical connector, the electrical connector comprising:
a base configured for secure insertion into an aperture defined by a bus bar, the base defining a bore having an inner diameter, and the base having a longitudinal axis;
a contact element disposed within the bore of the base, the contact element having a first end and a second end, the contact element defining a bore configured to receive a pin of the separable mating connector in continuous electrical engagement therewith, the contact element comprising:
a housing having a first end, a second end, an inner diameter, and an outer diameter lesser than the inner diameter of the bore of the base; and
a circumferential flange extending radially outwardly from the housing proximate the first end of the housing, the first circumferential flange having an outer diameter; and
a retainer receiving the contact element therein and capturing the contact element to the base,
wherein the diameter, the first radius, the second radius, and the inner diameter of the bore of the base are selected to allow substantial radial movement of the annular contact element with respect to the base; and
wherein the contact element is electrically engaged with the base and in press-fit engagement with an inner surface of the base.

18. The electrical connector of claim 17 further comprising a first array of flexible beams extending toward the second end of the housing of the contact element from a base disposed radially within the housing of the contact element and proximate the first end of the housing of the contact element.

19. The electrical connector of claim of claim 18 further comprising a second array of flexible beams extending toward the second end of the housing of the contact element from a base disposed radially within the base of the first array of flexible beams of the contact element and proximate the first end of the housing of the contact element.

20. The electrical connector of claim 19 wherein the contact element further comprises a ferrule having a shaft and a flange connected to the shaft at a first end thereof, the shaft received radially within the housing.
